(19) United States
(12) Patent Application Publication
(10) Pub. No.: US 2007/0277103 A1
(43) Pub. Date: Nov. 29, 2007

(54) Method, device, and input element for selecting the functional mode thereof

(76) Inventors: Wolfgang Theimer, Bochum (DE); Andree Ross, Luenen (DE); Thomas Schetelig, Bochum (DE); Reza Serafat, Bochum (DE)

Correspondence Address: Hollingsworth and Funk, 8009 34th Avenue South, Suite 125, Minneapolis, MN, 55425, US

(21) Appl. No.: 10/570,529

(22) PCT Filed: Sep. 18, 2003
(86) PCT No.: PCT/IB03/04016

§ 371 Date: Nov. 22, 2006

(51) Int. Cl. G06F 3/01

(52) U.S. Cl. 715/701; 700/245

(57) ABSTRACT

Systems, apparatuses and methods of selecting the functional mode of an input element for a mobile terminal device, the input element supporting at least two functional modes. The method involves receiving a request for providing an input element with a specific functional mode, and implementing the specific functional mode to provide an input element having the specific functional mode. A mobile terminal device is also provided which includes a multi mode input element supporting at least two functional modes, and a selection component which selects and implements one functional mode into said multi mode input element. A multi mode input element is provided which supports at least two functional modes, and a selection component which selects and implements one functional mode in said multi mode input element.

The present invention relates to adaptive haptics. More specifically, it relates to emulating the functional modes of specific input elements by a universal input element utilizing control characteristics and state transitions between different control characteristics. The invention is of special use in the environment of mobile terminal devices but not limited thereto.

Haptics, and its special case of force feedback effects, have been utilized for mainly two purposes so far. They are used in remote controlling robotic devices and the like. In order to successfully grab an item with a remote controlled robot for instance, haptics can be quite useful or even necessary. The gripping force applied to the item must be limited if the item is easily breakable, for example an egg or the like. So a human controller must receive a force feedback in order to grap an item with a suitable force. This object can be achieved by the use of haptic effects, giving some kind of haptic response when operating such robotic devices. The same argument may apply to applications like flight simulators, where haptics are used to simulate feedback effects on game controllers that real controllers would show.

In many computer games force feedback effects may increase the feeling of reality of a certain game. In car race or flight simulations force feedback is used to emulate a feedback that real controllers like steering wheels or the like would show. Also in the domain of computer applications, a mouse was given force feedback effects, mainly also for use in computer games, but also for haptically signaling if the mouse was over a certain dialog box, menu item or the like. Though the latter was not widely accepted, since the possible use of it was obviously small in combination with stationary computers.

A crucial problem related to mobile terminal devices like mobile phones or PDAs and the like, is the desire of a display as large as possible, while at the same time the devices itself should be as small as possible. This obvious paradox, large display surface on the one hand, and “pocketable” size on the other hand, can only be solved by reducing the space that the controls of the device take up. Thus it would be desirable to use only very few input elements, at best only one.

Another wish may be to use the mobile device without actually having to look at it.

So far force feedback effects or restoring forces for input elements have not been implemented in mobile terminal devices. There are at least two major problems which may avoid the use of force S feedback in compact mobile devices. The power consumption of force feedback elements can be considerably high, which is of course ambiguous in mobile devices comprising only a limited energy budget. Also, since force feedback elements in such compact mobile devices must be considerably small, they will certainly not be able to apply comparably strong forces, which may render the force feedback effects useless, because they are simply to “weak”.

Input elements used in mobile terminals as of today include joystick-like elements movable in at least 2 perpendicular dimensions, maybe additionally subject to be pressed or biased against the base plate, 4-way switches, also called rocker keys and rollers. Rotators are so far not used very widely, but may become more important in future types of mobile terminals. Those input elements are utilized according to the application that has to be controlled, like rollers or rotators serving as volume controls or the like, rocker keys for navigating menus and joystick-like elements for game applications and the like. In mobile terminals usually at least one or even all mentioned applications are present: navigation menus, games running on the terminal or an included mp3 player whose volume has to be adjusted. Providing a corresponding specific input element for each application is of course ambiguous to the reduction of space taken up by such control elements. Though on the other hand it improves ease of use and comfort.

In the development of a mobile phone it has rather early to be defined which kind of input element will be used. This is caused by the functions and features that have to be controlled, the menu structure and other preferences.

In the last years the use of games in mobile communication devices has strongly increased. Most games require to be controlled by an input element moveable in 2 dimensions or in other words in four directions, while for other usual menu functions one dimension, in other words up and down, is already suitable enough. It may often be also desirable to confirm an input or perform commands through pressing the middle of a joystick, rocker key or roller. So it is obviously desirable to integrate as many advantages of the aforementioned input elements in one single input element as possible.

With the advent of resistive or active force feedback, input elements have started to show a dynamic behavior which can be changed by applying a context-dependent force. In the automotive domain, the use of programmable haptics is already partly accomplished. Single mechanical input elements whose characteristics can be somehow adapted are incorporated in upper class automobiles. The best known example is the i-drive® knob used in the BMW® 7 series. This knob is programmable in the sense that the number of clicks or detents (i.e. the rasterization) can be programmed and the force feedback can be adjusted by software. Also vibra sensations are implemented here.

Present implementations are pre-programmed for single input situations only. That means for example to represent one menu in the hierarchy of a user interface. Also the degrees of freedom of movement of such mechanical input elements are fixed and cannot be changed or adapted dynamically. Force feedback effects are so far only used to support the operation of an input element, or in the gaming domain to achieve a more realistic game play. In other words, present implementations are restricted to closed input situations only; adapted for a single method of use or one specific purpose at once only.

In the document DE 4205875 A1 it is mentioned the use of a rotator in the BMW® 7 model, which returning forces are adaptable.

In the document EP 794089 A2 a similar rotator device as mentioned above is described, comprising more than one degree of freedom and can be indirectly controlled through speech input.

In the document U.S. Pat. No. 6,005,551 a sequence of haptic effects is performed. That means the output behavior is variable, but not dynamically controlled by the user or some other entity.

In the document U.S. Pat. No. 5,889,672 a “torque profile” describes the lower layer parameter of a vibra (actuator) device. It allows to adjust the behavior of the rotator shift of the actuator. Such a parameter set is normally stored on EEPROM or similar media located on the controller part of the device. Once you adjust them in one device, you are not able to modify that before reflashing the controller part.

In the document WO 98/43261 adaptable returning forces are described, especially for a rotator device, but also for a joystick. Emulating the functionality of a rotator with a joystick or vice versa is not described here.

The object of the present invention is to provide a flexible method of adapting haptics for different purposes and to provide an input element which integrates the advantages of several other conventional input elements.

Those objects are achieved by providing a method to enable an input element for a mobile terminal device to emulate the functional mode of different types of conventional input elements; utilizing control characteristics to restrict or allow certain degrees of freedom of the input element accordingly. A corresponding mobile terminal with a multi mode input element is provided, which emulates the functional modes of two or more conventional input elements through the use of control characteristics.

In a rocker key a tactile response, for example a click or the like, will inform the user that a direction key has been used or an input has been confirmed (like pressing an enter key). In a joystick that is used to control a game, such a click is usually unwanted, though there might be certain situations in the game where this though might be useful, if the mode of the game changes or if a different function shall be controlled. To scroll a list in another menu area a simple 1-dimensional control (2 directions), with or without a click, is already suitable enough. Through the use of adaptable restoring forces or resistive forces, such functions of an input element may be emulated by a kind of universal input element, which makes usage of a communication device more comfortable in different operating situations.

The mechanical state or position of input elements (and also output elements) can be described by a finite set of variables or coordinates. In the case of a rotator, a simple rotatable disc, the position is given by the rotation angle α, which is a 1-dimensional coordinate. In the joystick case spherical variables are the most convenient way to describe the position. The angle θ determines the direction of the joystick pointer, the tilt angle φ measures the deviation from the vertical axis and the radius r outlines if the joystick is pressed to the device surface. Normally this is a simple binary decision variable: pressed or not pressed. In the same manner switch or key functionality may be added to other input elements like the aforementioned rotator, by adding a binary variable and corresponding degree of freedom. An additional degree of freedom, to be rotatable around the z-axis, can easily be described by an additional angle.

According to the present invention, a method of selecting the functional mode of an input element for a mobile terminal is provided. The method comprises the steps of:
receiving a request for providing an input element with a specific functional mode;
implementing the specific functional mode to provide the input element with the functional mode.
   That means a request for an input element with a specific functional mode has to be satisfied (e.g. joystick, rocker key, roller). To achieve this, the specific functional mode is implemented to provide an input element accordingly.

It is preferred that the functional mode is implemented by applying a force feedback effect to the input element.

It is preferred, that the force feedback effect involves both a freedom and a restriction of the input element, respectively. That means certain degrees of freedom are allowed (freedom) while others are forbidden (restriction). This enables a kind of universal input element to adopt the behavior of conventional input elements of different type.

It is preferred that the force feedback effect is derived from a control characteristic, which assigns force feedback values to mechanical states of the input element. Using such control characteristic makes the method very flexible to satisfy different needs.

It is preferred that the control characteristic is generated according to parameters of the requested functional mode. That way not a plurality of control characteristics has to be stored, but a suitable control characteristic may be generated from relatively few parameters (degrees of freedom, restrictions etc.).

It is preferred that a state transition to a different control characteristic is triggered when the input element enters a predetermined mechanical state. That way, control characteristics may be handled very flexible. State transitions make it possible to build very complex operation situations.

According to another aspect of the invention a software tool is provided comprising program code means stored on a computer readable medium for carrying out the method of anyone of the preceding claims when said software tool is run on a computer or network device.

According to another aspect of the invention a computer program product is provided comprising program code means stored on a computer readable medium for carrying out the method of anyone of the preceding claims when said program product is run on a computer or network device.

According to another aspect of the invention a computer program product is provided comprising program code, downloadable from a server for carrying out the method of anyone of the preceding claims when said program product is run on a computer or network device.

According to another aspect of the invention a computer data signal is provided, embodied in a carrier wave and representing a program that instructs a computer to perform the steps of the method of anyone of the preceding claims.

According to another aspect of the present invention, a mobile terminal device is provided, comprising a multi mode input element supporting at least two functional modes and a component which selects and implements one functional mode into the multi mode input element.

It is preferred that the mobile terminal comprises a sensing element for determining a mechanical state of the input element and a selection component which selects and implements one functional mode into the multi mode input element based on the determined mechanical state.

It is preferred that the mobile terminal comprises a feedback component, adapted to apply a force feedback effect to the multi mode input element. The force feedback effect involves both a restriction and a freedom of the multi mode input element, respectively.

It is preferred that the mobile terminal comprises a storage. The force feedback effect is derived from a control characteristic assigning force feedback values to mechanical states of the multi mode input element, wherein the control characteristic is stored in the storage.

It is preferred that the mobile terminal comprises a processing unit adapted to generate a control characteristic according to parameters of a specific functional mode.

According to another aspect of the invention there is provided a multi mode input element supporting at least two functional modes, and a selection component which selects and implements one functional mode in said multi mode input element This input element can be used in other environment than just mobile terminal devices and can perform independent functions therein.

A multi mode input element is preferred which comprises a sensing element for determining a mechanical state of said multi mode input element, wherein said selection component selects and implements one functional mode into said multi mode input element based on the determined mechanical state.

Further, a multi mode input element is preferred comprising a feedback component adapted to apply a force feedback effect to said multi mode input element, said force feedback effect involving a freedom and restriction of said multi mode input element, respectively.

Further a multi mode input element is preferred comprising a storage, wherein said force feedback effect is derived from a control characteristic assigning force feedback values to mechanical states of said multi mode input element, wherein said control characteristic is stored in said storage.

Finally, there is preferred a multi mode input element comprising a processing unit adapted to generate a control characteristic according to parameters of a specific functional mode.

The accompanying drawings are included to provide a further understanding of the invention and are incorporated in and constitute a part of this specification. The drawings illustrate embodiments of the present invention and serve, together with the description, to explain the principles of the invention. In the drawings,

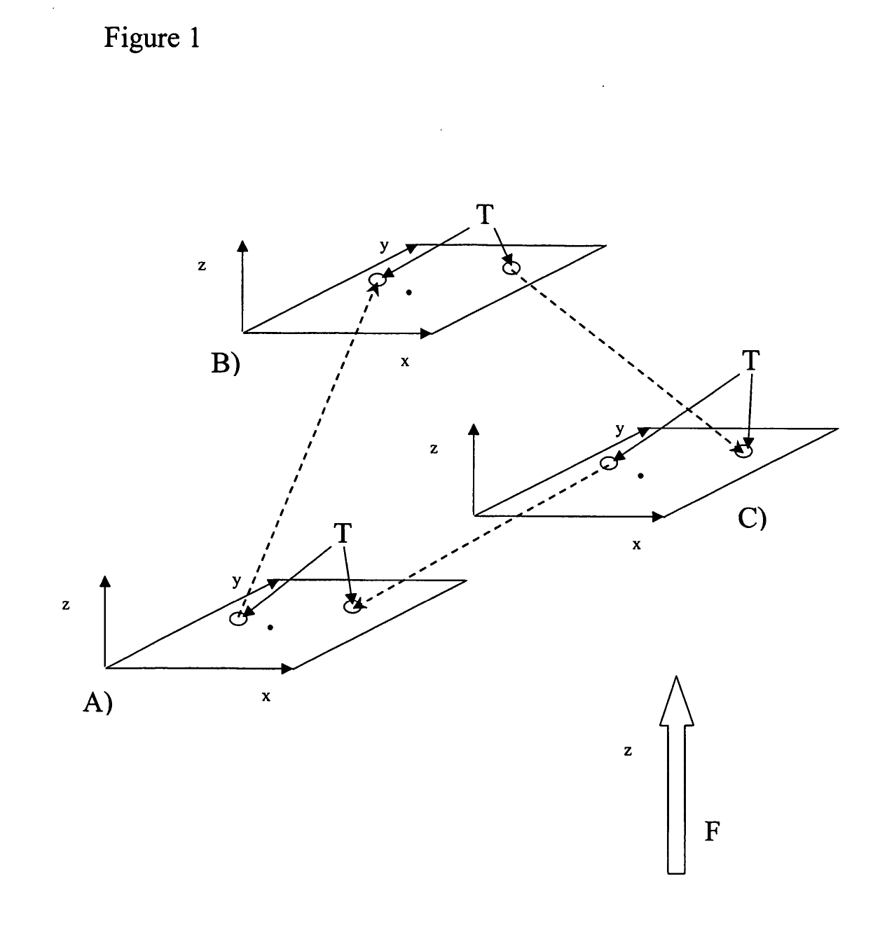

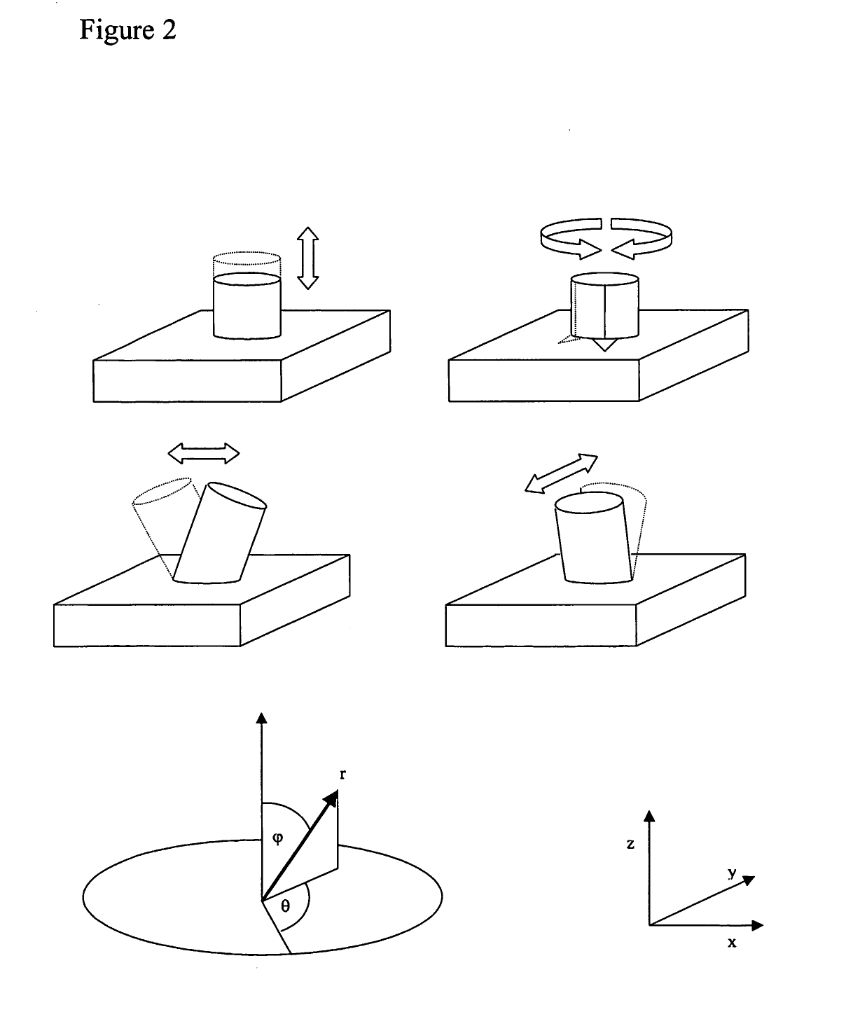

FIG. 1 illustrates a preferred embodiment of the present invention;

FIG. 2 illustrates another preferred embodiment of the present invention;

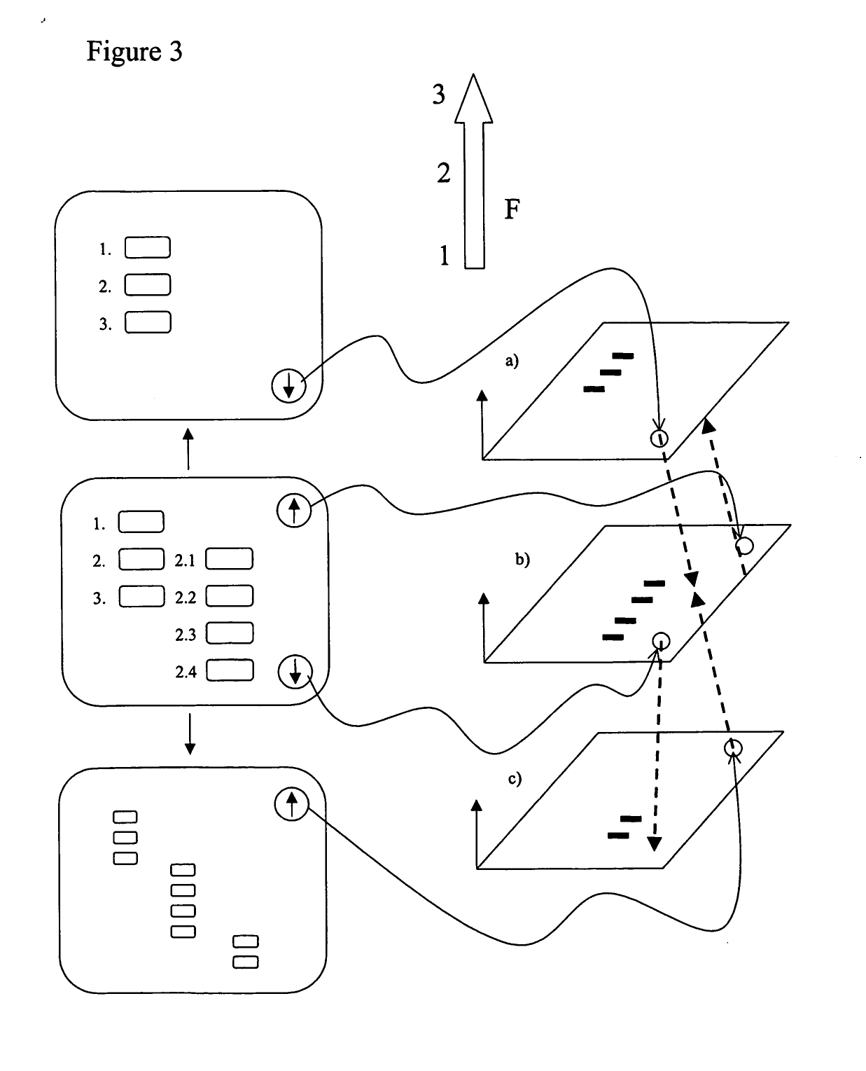

FIG. 3 illustrates another preferred embodiment of the present invention;

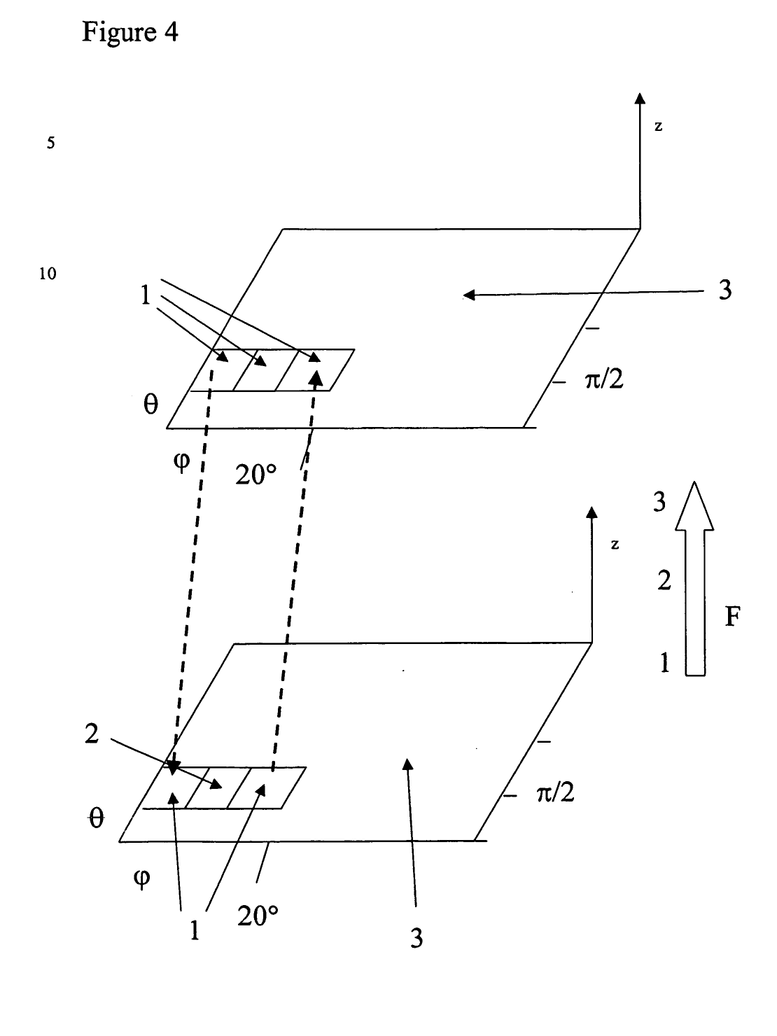

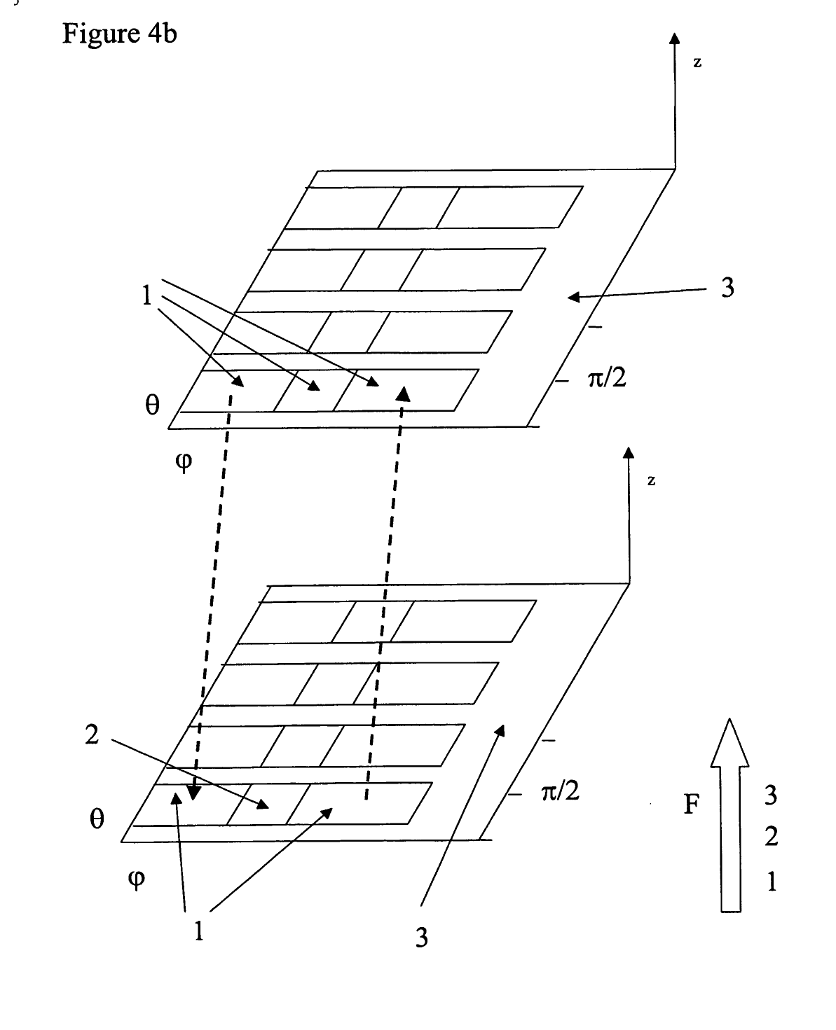

FIG. 4 illustrates another preferred embodiment of the present invention;

FIG. 4b illustrates another preferred embodiment of the present invention;

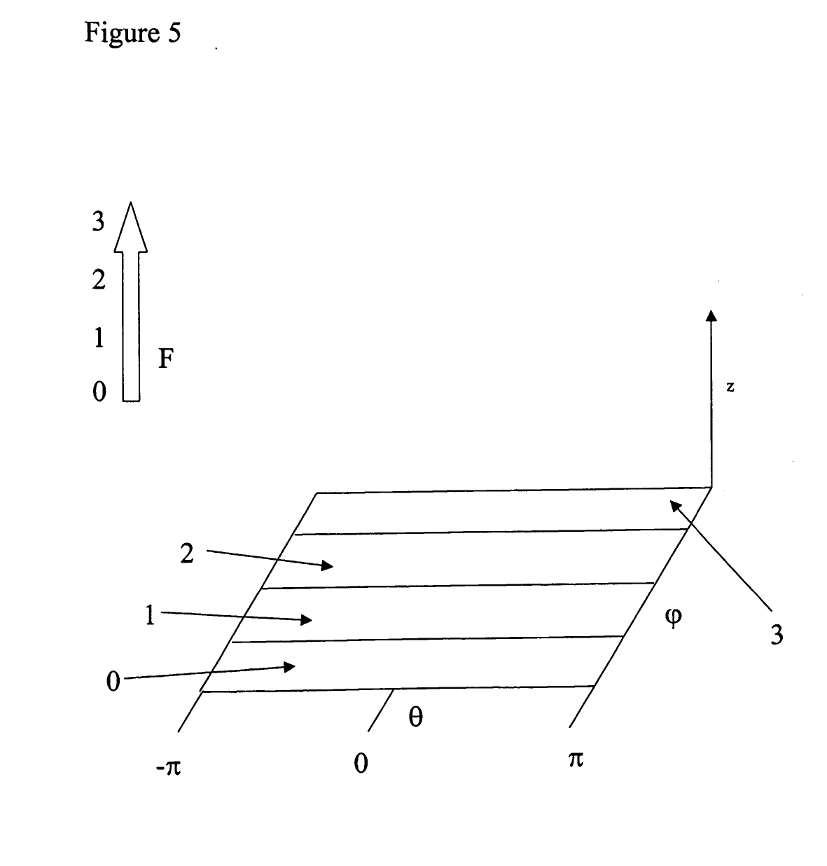

FIG. 5 illustrates another preferred embodiment of the present invention;

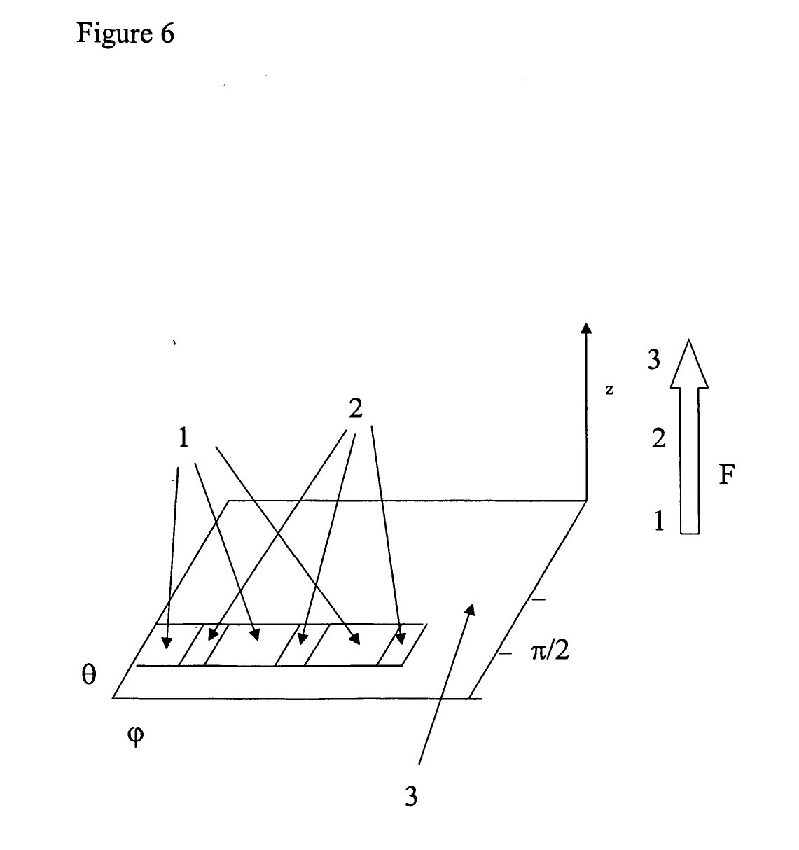

FIG. 6 illustrates another preferred embodiment of the present invention; and

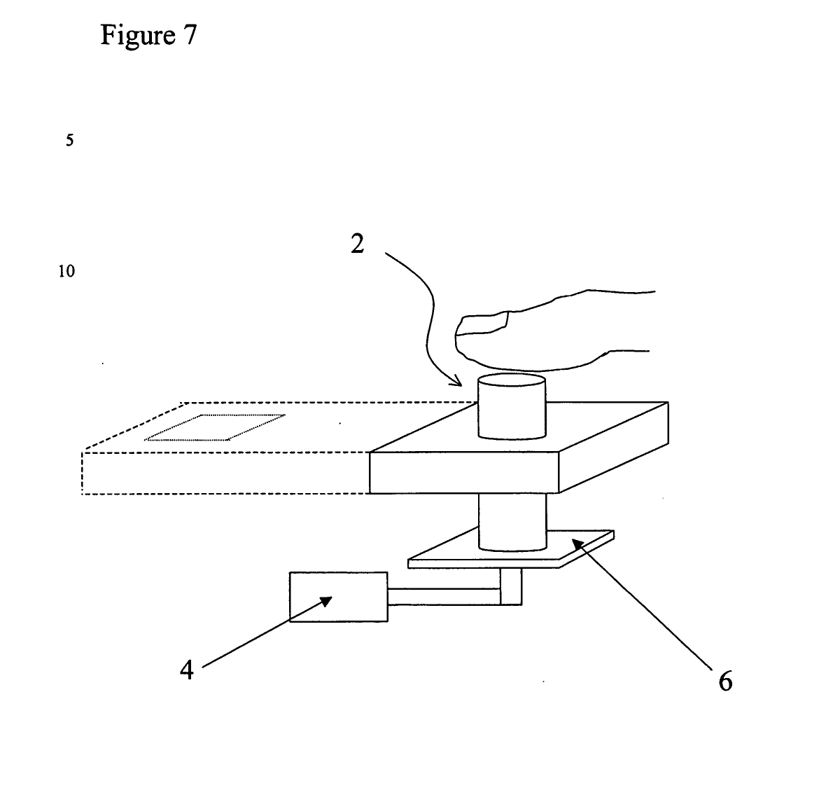

FIG. 7 illustrates yet another preferred embodiment of the present invention.

In this description, spherical coordinates for the position of the top of a mechanical input element may be used, with rε[0,f], θε]−π, π] and φε[0, π/ 2]. The mathematical concept of spherical coordinates is illustrated in FIG. 2.

In FIG. 1 control characteristics according to the invention are shown. An exemplary control characteristic A) consists of a two-dimensional region spanned by the x-and y-axis plus an additional z-axis. Force feedback strength increases with z, as illustrated by the F arrow. Such a control characteristic would be representative for a device, the mechanical state of which can be described by two coordinates, for example x and y. The corresponding control characteristic associates force feedback values with position values of the input element or in this case 2-cell tuples of x and y. For a given tuple corresponding to a certain position of the joystick a feedback value on the z-axis is assigned. If the position of the joystick reaches one of the T areas, a state transition to another control characteristic, either B) or C) occurs. Now this new control characteristic is used to lookup force feedback values corresponding to the joystick position. A T area in a different location leads back to the starting control characteristic.

These exemplary control characteristics are rather simple, associating 2-dimensional positions in the x-y plane with scalar force feedback values on the z-axis. It is possible, but not as easy to illustrate, to use control characteristics associating more than 2-dimensional position values, additional rotation around the z-axis of an input element, input element pressed or not, and the like, with vector feedback values. Thus not only assigning a strength of a certain feedback effect, but also a direction in which the force feedback effect shall be applied. Such control characteristics can thus be constructed very flexible up to really complex assignments, giving desired force feedback values and directions for many desired actual configurations of an input element.

In FIG. 2 an input element according to the present invention is illustrated. A joystick is shown here, which possesses different degrees of freedom. Spherical coordinates used here are illustrated, compared to an also shown cartesic coordinate system. The joystick may be pressed, which is measured by the radius r, which has a smaller value when pressed compared to a larger value when not pressed. It may be rotated around its z-axis, which cannot be described by the standard spherical coordinates, but may be measured with an additional angle α. The pointer of the joystick may be moved in the y-direction of a cartesic coordinate system, which means angle ∴ being zero (forward movement) or π (backward movement), while the tilt angle φ is variable corresponding to how far the pointer of the joystick is moved. Similarly the pointer of the joystick may be moved in the x-direction (left or right) of the cartesic coordinate system, in this case angle θ being either π/2 (movement to the right) or −π/2 (movement to the left). Of course all these possible movements can be superposed. A joystick device as shown here may suit as a basis for an adaptive joystick implementation, which can be dynamically switched between analog joystick, rocker and roller mode or even more exotic operation modes.

In FIG. 3 a simple application is illustrated, in this case to switch between different menu hierarchies in a user interface. Here a user interface containing a menu hierarchy with 3 levels is shown. When the position value of a corresponding input element reaches the “up”-area of control characteristic b), a transition to control characteristic a) is performed and the user interface switches to the top menu level. When reaching the “down”-area of control characteristic b), a transition to control characteristic c) is performed and the user interface switches to the bottom menu level. A tactile sensation gives the user feedback when hitting a state transition area, indicating that menu levels have been switched. In the respective control characteristics, menu items 1 to 3, or 2.1 to 2.4 etc. may additionally be marked by a different feedback value than the rest of the menu surface and the transition areas, as illustrated in the control characteristics. Thus the user could not only visibly, but also haptically sense the menu structure. This could be achieved by applying a returning force feedback effect when entering the area corresponding to a certain menu item, in other words to build an attractor towards the menu item. For each menu level the corresponding control characteristics represent the menu items, 3 on the top level, 4 on the middle level and 2 on the bottom level in this case. Of course the user can switch back from top or bottom menu to the middle menu, for example ending in the middle of the control characteristic corresponding to the middle menu, to avoid accidental unwanted backswitching to a menu level just left. Generally, state transition zones or areas within the same control characteristic should always be substantially separated when in a menu operation environment or the like, otherwise unwanted state transitions may easily occur. In other application this may not be the case or even be wanted.

In FIG. 4 a control characteristic corresponding to a simple 1-way rocker key or switch is shown. The feedback force increases with z, illustrated by the arrow F. Here the universal mechanical input element is restricted by a zone 3 to a small area around θ=π/2 and with an angle φ from 0 to for example 20°. That means the switch can be moved horizontally a little to the right side. If the user moves the switch out of the zero position, the tilt angle φ increases. So far the input element moves in a zone 1 with low returning force feedback. If the angle increases even more the element reaches zone 2 with medium resistive force feedback. If the user applies medium force to cross this zone the input element reaches another zone 1. Crossing this zone is sensed by the user as a kind of click (surmounting a resistive force). Here a state transition occurs, to a control characteristic wherein the medium resistive force feedback zone 2 is cleared, and the input element can thus return to its zero position, following the low returning force feedback. Having reached the zero position, a transition back to the first control characteristic occurs and the rocker key is ready for another interaction cycle. To cause a function to be executed by clicking the rocker key, the transition between the two control characteristics can of course be associated with a corresponding event that shall be triggered or switched by the rocker key.

In FIG. 4b the concept of the n-way rocker key is illustrated with n equal to 4. Movement is possible with such a 4-way rocker key in the horizontal direction (left or right), in the vertical direction (up or down), and in two additional directions which are inclined at an angle of 45° to one of the aforementioned directions, respectively (left-up, right-up, right-down and left-down). The corresponding haptic map is similar to those of the simple 1-way rocker key, or in other words 4 of those simple maps for 4 different angles θ=0, π/4, π/2, 3/4 π or π, respectively. Movement in each of the 4 possible ways works according to the simple 1-way rocker key of FIG. 4. When the user moves the joystick out of the center position with tilt angle zero some directions are blocked indicating that the rocker can only be moved in certain directions to implement an N-way rocker. In this figure a four-way rocker is shown where small regions around θ=−π, −π/2, 0, π/2 are blocked by high resistive forces (zone 3). Once the input element is moved in allowed regions and the tilt angle θ increases there is a resistive counter-force, (zones 2). If the user applies a larger force to overcome this medium resistance, the tilt angle increases further and ends in a zone 1. A further increase of the tilt angle to values near π/2 is prohibited by a large resistive force (zone 3). Once the input element has passed the intermediate (zone 2) tilt region and reaches the zone 1 with larger tilt angle a state transition of the haptic map occurs. The consequence is that the intermediate zone 2 with resistive forces is cleared allowing the rocker to return to the central position with tilt angle zero. If the rocker arrives there again a state transition back to the first state occurs. To achieve a rocker movable in 8 directions, negative values of φ are simply handled by using their absolute values.

In FIG. 5 a control characteristic corresponding to a conventional analog joystick is shown. The feedback force increases with z, illustrated by the arrow F. The angle θ can have any value from −π to π, meaning that the joystick pointer can be moved in every direction, while the tilt angle φ is restricted again to a range of 0 to 20°, meaning that the joystick pointer can deviate from the vertical axis only be a certain amount. The returning force is always directed to zero, and its absolute value depends solely on the value of the tilt angle φ. For that purpose certain zones, in this example ranging from 0 to 3 are defined, with returning forces monotonely increasing with zone number. Of course a much greater number of zones will be used in an actual quasi-analog control device for gaming purposes for example. Values greater than 20° or another fixed suitable limit cause strong returning forces according to zone 3 that cannot be surmounted. On the z-axis only the value for the returning force feedback effect is measured, the direction in which it is applied must be derived from the coordinates of the joystick pointer. The control characteristic in this case emulates a spring-based element of a conventional analog joystick ensuring a returning force to the center position (tilt angle φ zero).

In FIG. 6 a control characteristic corresponding to a roller input element is shown. The feedback force increases with z, illustrated by the arrow F. The angle θ is restricted to a small area around π/2 by a zone 3 with strong resistive force feedback. Angle φ may range from 0 to π. That means that the input element can be rotated to the right for half a complete turn. A number of detents can be defined, for the sake of rasterization. In this case 3 detents are defined. Each detent is characterized by an increased resistive force feedback in zones 2 that has to be surmounted compared to low or zero resistive force in zones 1. Such a roller may also be realized as a rotating disc or rotator. It must be noted that instead of the angle θ a kind of linear coordinate or angle α may be used, in that manner also angles greater than π may be reached, if this is desired.

In FIG. 7 an input element 2 according to the invention is shown. In this case it is a kind of mini-joystick, to be operated by the users thumb. A sensing element 4 is attached to the control stick of the joystick, it serves to determine the mechanical state of the joystick, i.e. to measure the position or the value of each degree of freedom. A feedback component 6 is attached to the control stick, by a kind of simple lever, to apply force feedback effects to the joystick.

The aforementioned examples are only some possible ways of providing specific types of input elements. Utilizing the methods described, it is easy to realize even more exotic input elements behaving like a gear lever in its gear lever gate in a racing game or the like.

There are at least two major haptic or force feedback effects. First there is resistive force feedback, which could be realized by a kind of braking device with adjustable break force. And second push or pull feedback, in which case a push or pull force into a certain direction is sensed by the user. The latter could be realized by some kind of magnetic driving force applied to the input element. Resistive feedback has a solely scalar value corresponding to the breaking force. Force feedback pushing or pulling the input element in a certain direction, for example a returning force, is a vector instead, the vector giving information about the scalar value of the force through its absolute value, while also giving information about the direction in which the push or pull force is applied. Apart from resistive feedback forces other variants may be suitable in certain situations while usually returning force feedback effects are used as active force feedback effects, applying a force in a direction opposite to the direction the user is moving the input element. Certain “attractor” areas may be defined by utilizing a returning force that attracts the input element to a certain area, for example corresponding to a menu item or the like.

To make use of control characteristics a mechanical input element is needed. In order to be able to emulate a wide variety of conventional input elements the mechanical input element used should offer many different degrees of freedom. Common possibilities are best described using a kind of joystick normally used in computer gaming applications. Such an input element may have some of the following ways of being moved or operated:
rotation around the y-axis, the top of the controller moving along the x-axis;
rotation around the x-axis, the top of the controller moving along the y-axis;
rotation around the z-axis;
being pressed against its base plate.
   These are the most common kinds of movements. Additional other possibilities of movement may also be realized.

The adaptive haptics concept according to the present invention is based on state transitions between different control characteristics. The mechanical state or position of the tactile input element is continously scanned by the firmware of the mobile terminal. Once the user moves the tactile input element into a defined mechanical state change region in the control characteristic, a state transition to a new control characteristic takes place. In this case the mechanical state change is user-induced, or one might also say it is dynamically within the control characteristic. Another possibility may be to alter the control characteristic, or in other words to trigger a state transition, by an application running on the mobile terminal. Many possibilities for such a behavior may seem useful, like in a game, after a certain time period has expired or the like, or for example to synchronize the control characteristic with a display frame rate in a game or based on an external event like changes in the gaming situation. Such a behavior could thus be called application-induced. Alternatively external entities can drive state changes of the control characteristics. A service running on a network, where the mobile terminal is connected to, may take an according action, or maybe a distant user of another terminal on the same network. It has to be noted that state changes may be dependent on the selection of an input choice, e.g. pressing the rotator element, or can be performed without direct selection of the input choice.

The use of control characteristics and state transitions offers tremendous flexibility. Using a kind of universal mechanical input element and emulating a number of special conventional input elements therewith makes it possible to reduce the total number of input elements used in a mobile terminal. The directional guiding achieved by restricting certain degrees of freedom of the input element may suit to support different physiognomies of users, e.g. small hands versus large hands. Through state transitions between different control characteristics very complex operation scenarios can be realized. Those may be used for purposes of operating mobile terminal devices intuitively or even without actually looking at the terminal display. A transition of the control characteristics may be triggered or controlled by many different events or entities, either internal or external, even on the fly during operation, as part of a software state or the like. External events or entities can be services running on the network, where the terminal is connected to, applications on the terminal, distant users (in terminal interaction) and the user himself (adaptive behavior). Haptic behavior may thus also be made self-learning, meaning that the force applied through a force feedback effect can be automatically adapted to the individual user.

1. Method of selecting the functional mode of an input element for a mobile terminal device, said input element supporting at least two functional modes, the method comprising:
receiving a request for providing an input element with a specific functional mode; and
implementing said specific functional mode to provide an input element having said specific functional mode.

2. Method according to claim 1, wherein said specific functional mode is implemented by applying a force feedback effect to said input element.

3. Method according to claim 1, wherein said special functional mode involves freedom and restriction of said input element.

4. Method according to claim 2, wherein said force feedback effect is derived from a control characteristic assigning force feedback values to mechanical states of said input element.

5. Method according to claim 4, wherein said control characteristic is generated according to parameters of said specific functional mode of said input element.

6. Method according to claim 4, wherein a transition to a different control characteristic is triggered when said input element enters a predetermined mechanical state.

7. Software tool comprising program code means stored on a computer readable medium for carrying out the method of claim 1 when said software tool is run on a computer or network device.

8. Computer program product comprising program code means stored on a computer readable medium for carrying out the method of claim 1 when said program product is run on a computer or network device.

9. Computer program product comprising program code, downloadable from a server for carrying out the method of claim 1 when said program product is run on a computer or network device.

10. Computer data signal embodied in a carrier wave and representing a program that instructs a computer to perform the steps of the method of claim 1.

11. Mobile terminal device, comprising a multi mode input element supporting at least two functional modes, and a selection component which selects and implements one functional mode into said multi mode input element.

12. Mobile terminal device comprising a multi mode input element according to claim 11, comprising a sensing element for determining a mechanical state of said multi mode input element and a selection component which selects and implements one functional mode into said multi mode input element based on the determined mechanical state.

13. Mobile terminal device according to claim 11, comprising a feedback component adapted to apply a force feedback effect to said multi mode input element, said force feedback effect involving a freedom and restriction of said multi mode input element, respectively.

14. Mobile terminal device according to claim 11, comprising a storage, wherein said force feedback effect is derived from a control characteristic assigning force feedback values to mechanical states of said multi mode input element, wherein said control characteristic is stored in said storage.

15. Mobile terminal device according to claim 11, comprising a processing unit adapted to generate a control characteristic according to parameters of a specific functional mode.

16. Multi mode input element supporting at least two functional modes, and a selection component which selects and implements one functional mode in said multi mode input element.

17. Multi mode input element according to claim 16, comprising a sensing element for determining a mechanical state of said multi mode input element, wherein said selection component selects and implements one functional mode into said multi mode input element based on the determined mechanical state.

18. Multi mode input element according to claim 16, comprising a feedback component adapted to apply a force feedback effect to said multi mode input element, said force feedback effect involving a freedom and restriction of said multi mode input element, respectively.

19. Multi mode input element according to claim 16, comprising a storage, wherein said force feedback effect is derived from a control characteristic assigning force feedback values to mechanical states of said multi mode input element, wherein said control characteristic is stored in said storage.

20. Multi mode input element according to claim 16, comprising a processing unit adapted to generate a control characteristic according to parameters of a specific functional mode.

21. Method according to claim 1, wherein a transition from one control characteristic to a different control characteristic is triggered when said input element enters a predetermined mechanical state.

22. Mobile terminal device according to claim 12, comprising a feedback component adapted to apply a force feedback effect to said multi mode input element, said force feedback effect involving a freedom and restriction of said multi mode input element, respectively.
